(19) United States
(12) Patent Application Publication
(10) Pub. No.: US 2003/0053131 A1
(43) Pub. Date: Mar. 20, 2003

(54) Image processing apparatus, image forming apparatus and method thereof

(76) Inventor: Akihiro Moro, Kawasaki-shi (JP)

Correspondence Address: FOLEY AND LARDNER, SUITE 500, 3000 K STREET NW, WASHINGTON, DC, 20007, US

(21) Appl. No.: 09/953,616

(22) Filed: Sep. 17, 2001

(51) Int. Cl. B41F 1/00; G06F 15/00

(52) U.S. Cl. 358/1.17; 358/1.2; 358/1.9

(57) ABSTRACT

An image processing apparatus includes an discrimination unit to discriminate an image sort of provided image data and output discrimination information, a memory unit to store processing information including the discrimination information with image data, an image processing unit to read out the processing information and the image data and perform image processing indicated by the processing information for each domain of the image data in response to a sort of the processing information, and an image forming unit to perform image formation on an image recording medium on the basis of the image data provided with the image processing.

### BACKGROUND OF THE INVENTION

In recent years, an image forming apparatus such as a digital copying machine or the like has been rapidly prevailed in an office. A monochrome digital copying machine as one in place of a conventional monochrome analog copying machine has been prevailed. However, a color digital copying machine and a color laser printer are mainly used in a graphic design company, since a cost of machines and a cost for printing are higher.

On the other hand, the costs of a color laser printer and a color ink jet printer are lowered for the past few years, so that they are more used in a general office and a home. Alternatively, color printing of a newspaper, a magazine or the like has been developed in recent years.

Additionally, digital color copying machines are manufactured by many manufactures and a digital color copying machine having a high productivity, which is provided with a printer unit in a four-tandem system, is manufactured.

A color-printed document and a color-printed material such as a magazine or the like are increased in a market in this way, so that color-copying of a plurality of handouts to be used in a meeting at the office for short time and with a high speed is demanded. Therefore, the demand of a digital color copying machine having an electronic sort function as same as the conventional monochrome copying machine and capable of realizing a high quality color picture has been increased.

However, the digital color copying machine currently on sale is not provided with an electronic sort function and is not capable of processing an image with a high speed, since the manufacturing cost becomes higher if the memory capacity or the like is increased for the electronic sort function is provided. The digital color copying machine only having a memory copy function capable of copying a plurality of the same scripts at one scan in the case of forming the plurality of the same scripts or the digital color copying machine capable of realizing a reduction version copy like a Nin1 is on sale from some companies.

On one hand, one of manufactured digital copying machines has a function in a script mode such as an AI mode to discriminate a mode for each script and perform image processing as automatically switching to an optimum image processing.

Such a machine is provided with a mode to determine the discrimination for each script by a pre-scan and automatically switch to an optimum image processing in response to a determined result by a main scan after the pre-scan.

Alternatively, for the past few years, a hardware technique for making the image processing with a high picture quality into an ASIC with a high speed and a high density has been realized and its demand is increased, so that a cost for hardware has been decreased.

Thus, the color-printed document and the color-printed material such as a magazine or the like are increased in a market in the actual condition. The digital color copying machine having a memory copy function so as to increase efficiency thereof by copying at one scan in the case of forming a plurality of the same scripts or having a function to reduce a plurality of scripts into one piece to copy it as a Nin1 function is now on sale.

In such a conventional digital color copying machine, a machine provided with an electronic sort function as same as a conventional monochrome copying machine is needed according to demand for color-copying a plurality of scripts efficiently and for a short time in response to speeding up of copying. In order to realize this electronic sort function, a memory to store page information of a plurality of scripts is needed. Further, in order to store image data as it is read by a scanner, an enormous memory capacity is required.

However, by a function of memory copy and a Nin1 function which are mounted on a digital color copying machine now on sale, a script image mainly composed of a character, a script image mainly composed of a photograph and a script image in which a character and a photograph are mixed are processed in the same script mode. As this example, Japanese Patent Application Laid-Open No. 11-98359 is considered.

Accordingly, in the case that the script image mainly composed of a character, the script image mainly composed of a photograph and the script image in which a character and a photograph are mixed are copied at the same time, it becomes difficult to maintain a gradation sequence of a photograph image with emphasizing a contrast in a portion mainly composed of a character, so that this involves a problem such that an optimum picture quality is not obtained.

### BRIEF SUMMARY OF THE INVENTION

An object of the present invention is to provide an image forming apparatus and an image forming method capable of forming an image with a high picture quality in such a manner that a domain discrimination result of a script image is stored together with image data in a memory and an appropriate image processing is performed for each domain in response to the domain discrimination result to make the most of a property in each domain.

The present invention provides an image forming apparatus comprising an discrimination unit which discriminates an image sort of the provided image data and output discrimination information; a memory unit which stores processing information including the discrimination information from the discrimination unit together with the image data; an image processing unit which provides the image processing indicated by the processing information for each domain of the image data by reading out the processing information and the image data from the memory unit and associating the processing information and the image data with a sort of the discrimination information; and an image forming unit which forms an image on an image recording medium on the basis of the image data provided with the image processing to be provided from the image processing unit.

In the image forming apparatus according to the present invention, the processing information including the discrimination information of image sorts of the images is stored together with the image data and predetermined processing is performed to the image data in response to the processing information including the discrimination information upon reading out this image data in the above described constitution. Therefore, for example, even if a character/line drawing domain and a photograph domain are mixed in the image data, it is possible to automatically form a high quality image of the character/line drawing domain in which a contrast of the image is stronger in the character/line drawing domain as well as it is possible to automatically form a high quality image of the photograph domain in which gradation sequence is maintained while original photograph information is also maintained without setting particular image processing by a user. As a result, according to the present invention, even if the domains of plural sorts of images are mixed in the image data, it is possible to provide an image forming apparatus capable of forming a high quality image as a whole.

### BRIEF DESCRIPTION OF THE SEVERAL VIEWS OF THE DRAWING

FIG. 1 is a block diagram for illustrating an example of major parts of image processing according to the present invention;

FIG. 2 is a block diagram for illustrating an example of an image processing apparatus to perform the image processing according to the present invention;

FIG. 3 is an explanatory diagram for explaining the image processing according to the present invention;

FIG. 4 is an explanatory diagram for explaining 4in1 processing by using the imaging processing according to the present invention;

FIG. 5 is an explanatory diagram for explaining the image processing without using the present invention; and

FIG. 6 is an explanatory diagram for explaining the 4in1 processing without using the present invention.

### DETAILED DESCRIPTION OF THE INVENTION

An embodiment according to the present invention will be explained in detail with reference to the drawings below.

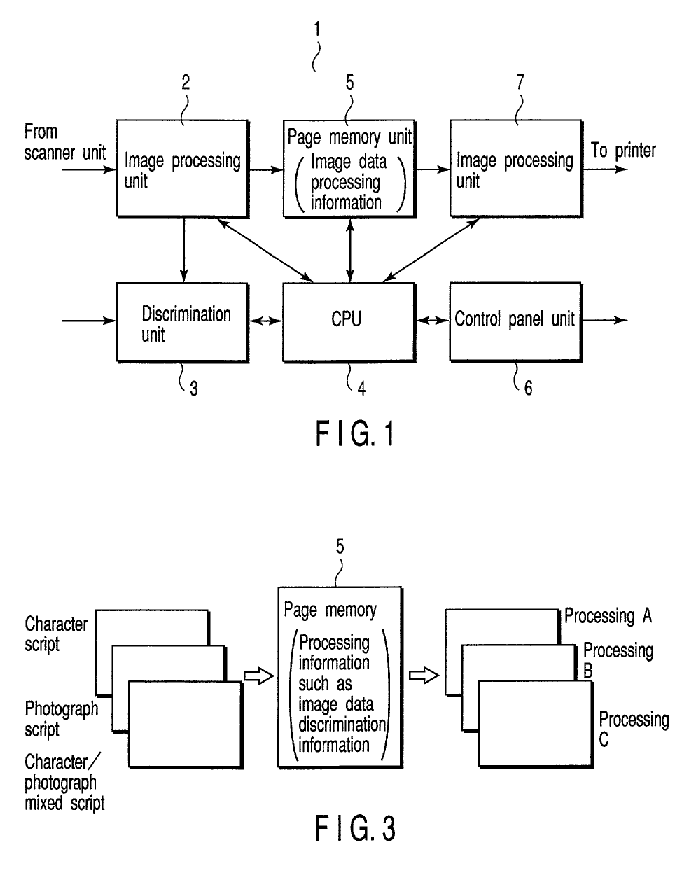

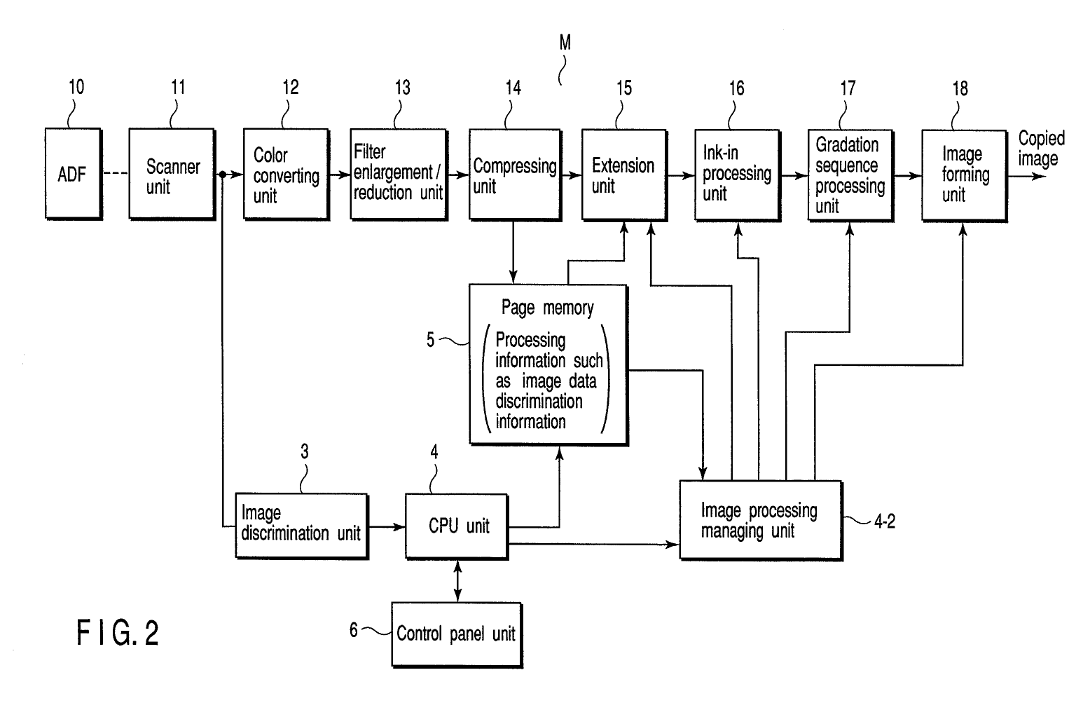

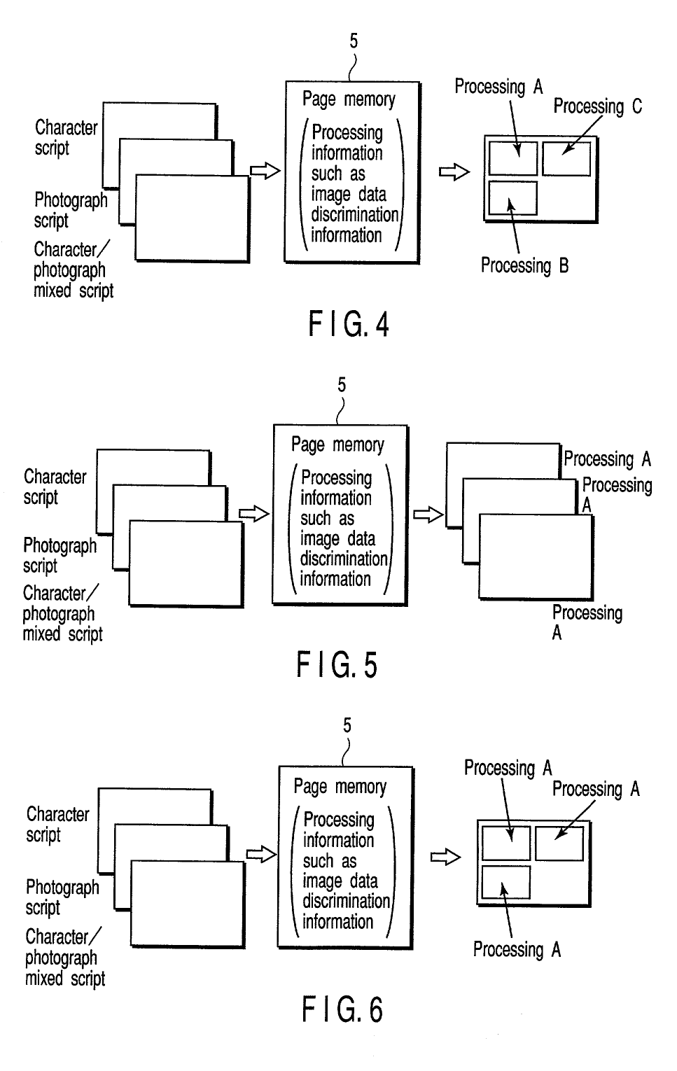

FIG. 1 is a block diagram for illustrating an example of major parts of image processing according to the present invention, FIG. 2 is a block diagram for illustrating an example of an image processing apparatus to perform the image processing according to the present invention, FIG. 3 is an explanatory diagram for explaining the image processing according to the present invention, FIG. 4 is an explanatory diagram for explaining 4in1 processing by using the imaging processing according to the present invention, FIG. 5 is an explanatory diagram for explaining the image processing without using the present invention and FIG. 6 is an explanatory diagram for explaining the 4in1 processing without using the present invention.

An example of an image processing apparatus 1 according to the present invention shown in FIG. 1 has an image processing unit 2 which is provided with image data from a scanner unit to be described later and which performs image processing before storing the image data in a page memory and an image discrimination unit 3 which automatically discriminates an image sort of this image data. Further, the image processing apparatus 1 shown in FIG. 1 has a page memory unit 5 which holds image data and processing information for each page, an image processing unit 7 which performs image processing after storing the image data in the page memory, a control panel unit 6 which performs user setting and a CPU 4 which manages the processing information from the image processing unit 2 and the setting information from the control panel unit 6, and which is capable of storing the processing information in the page memory or is capable of setting a parameter in the image processing units 2 and 7 and the image discrimination unit 3.

Such image processing apparatus 1 operates so as to perform the image processing according to the present invention as follows. A case such that the control panel unit 6 selects an automatic processing mode to designate the processing according to the present invention to be described below in addition to setting of copying in a script automatic discrimination mode (AI mode or the like), a full color and a manual density to copy will be explained below. Alternatively, the automatic processing mode is freely selected. If the automatic processing mode is not selected, a normal full-color copying will be carried out.

At first, the image discrimination unit 3 discriminates a script of image data which is provided by the pre-scan performed by the scanner unit to be described later. In other words, the script is fed from an ADF to be described later to pre-scan the script, so that the image discrimination unit 3 discriminates the script in macro. Then, the CPU 4 reads this discrimination result of the image discrimination unit 3 (a character script, a photograph script or the like).

Further, by a main scan, the processing parameter is set in the image processing units 2 to read the script by the script discrimination result determined by the pre-scan and the control panel setting information (full color, a manual density). Then, the result processed by the image processing units 2 is stored in the page memory unit 5. Alternatively, the script discrimination result determined by the pre-scan and the processing information including the setting information set by the control panel setting are associated to be stored in the page memory 5 together with this processing image data.

In the same way, a next script is read from the ADF and the processing from the above described pre-scan of the script to storing of the script in the page memory unit 5 is repeated. Alternatively, the control panel setting information upon using the ADF is same in one job, so that this storing processing may be performed in increments of a job.

If all scripts are completely read, then, image formation will be performed. Further, the processing information stored in the page memory unit 5 is read out, the processing parameter corresponding to this processing information is set in the image processing unit 7, the corresponding image data on the page memory unit 5 is read out, the image processing is performed by the image processing unit 7 and further, an image forming unit to be described later performs image formation according to the image data provided with this image processing.

In the same way, next storing data and next processing information are read out from the page memory unit 5, a processing parameter in association with the read out processing information (as one example, the processing information including the setting information and the discrimination information) is set in the image discrimination unit 3, the image processing in response to this processing parameter is performed by the image processing unit 7 with respect to the read out image data and the image is formed by the image forming unit to be described later.

Thus, owing that the image processing is automatically performed in association with the discrimination information for each image (for each domain), as shown in FIG. 3, the optimum image processing for each script image in response to sorts of images, such as processing A, processing B and processing C, is automatically assigned and these processing are performed. On the contrary, in FIG. 5, the uniform processing A is only performed with respect to different sorts of the script images such as a character script, a photograph script, a script/photograph mixed script or the like. In other words, for example, if the script is a character script, the ink in processing is automatically selected to be performed and if the script is a photograph script, the gradation sequence processing is automatically selected to be performed.

Additionally, upon the automatic script discrimination in the image discrimination unit 3, it is preferable that the processing information is stored in the page memory unit 5 to be processed by using the page memory unit 5 without the pre-scan. Further, it becomes possible to add the discrimination information of the image discrimination unit 3 in the page memory unit 5 as the processing information in association with the image data after processing the image in the image processing unit 2. Therefore, it becomes possible to prevent slippage of the script upon reading the script, so that it is possible to improve productivity owing to reduction of scanning time of a plurality of scripts.

Furthermore, according to another embodiment of the present invention, an embodiment by using a Nin1 function in conjunction with the above described automatic processing mode will be explained with reference to the drawings below. A case such that the Nin1 mode is selected together with the above described automatic processing mode of the present invention to copy will be described below.

At first, as shown in FIG. 6, each of the image data of a plurality of scripts, which are continuously read by the ADF to be described later, are uniformly provided with, for example, the processing A, even if, for example, one script is a character script, another script is a photograph script and other script is a character/photograph mixed script. Accordingly, the same processing A is provided regardless of image sorts of three pieces of image data and a synthesized image of 4in1 is reduced to be formed on one piece of a recording medium. In this case, it is not possible to obtain an image with a high picture quality due to the image processing in conformance with each image sort.

On the other hand, by using the automatic processing mode according to the present invention and the Nin1 mode together, as shown in FIG. 4, for example, the processing A in association with a character script, the processing B in association with a photograph script and the processing C in association with a character/photograph mixed script are automatically selected, respectively, to be provided to each of image data continuously read by the ADF. Therefore, synthesized image of 4in1, which is provided with the optimum image processing in response to the image sort to be reduced, is formed on a piece of the recording medium. Accordingly, a user can perform the image forming such as Nin1 or the like with a high picture quality in association with the image sort only by selecting the automatic processing mode and the Nin1 mode and continuously reading a plurality of scripts by the ADF or the like.

<Image Forming Apparatus According to the Present Invention>

Next, a concrete example of an image forming apparatus according to the present invention will be explained in detail with reference to the drawings. In FIG. 2, a color digital copying machine M serving as an image forming apparatus comprises an ADF (auto document feeder) 10 to continuously feed the script and supply it to a script table and a scanner unit 11 to output color script image data by scanning the script when the script is supplied to the script table. Further, the color digital copying machine M shown in FIG. 2 comprises an image discrimination unit 3 to discriminate image sorts of the color image data supplied from the scanner unit 11 and output discrimination information, a CPU unit 4 having a CPU (central processing unit), to which the discrimination information is supplied from the image discrimination unit 3, and which manages the entire operation, and a control panel unit 6 connected to the CPU unit 4 and enabling the user to operate this color digital copying machine M.

Further, the color digital copying machine M shown in FIG. 2 comprises a color converting unit 12 to convert a color of the color image data supplied from the scanner unit 11 before the color image data is stored in the page memory 5, a filter enlargement/reduction unit 13 to perform the filter processing to the image data, of which color is converted, and a compressing unit 14 to compress the image data with a predetermined compression ratio before the image data is stored in the page memory unit 5. Under the control by the CPU unit 4, the image data scanned by the scanner unit 11 is compressed to be stored in the page memory unit 5 with being associated with the processing information such as the discrimination information or the like.

Further, the color digital copying machine M comprises an image processing managing unit 4-2 to manage the image processing so as to perform the image processing in response to the image sorts together with the CPU unit 4 upon reading out the image data from the page memory unit 5 and an extension unit 15 to extend the image data read out from the page memory unit 5 in response to the compression ratio by which the image data is compressed. Further, the color digital copying machine M comprises an ink-in processing unit 16 to provide ink-in processing to the extended image data in response to the image sorts, a gradation sequence processing unit 17 to perform gradation sequence processing mainly with respect to a photograph image or the like and lastly, an image forming unit 18 serving as a printer unit to form an image on a recording medium in response to the image data provided by using a photo conductor drum, a transfer apparatus or the like, which are not illustrated in the drawing.

The image forming apparatus according to the present invention basically performs the same operation as that of the above described image processing apparatus. The image processing unit 2 shown in FIG. 1 corresponds to the color converting unit 12, the filter enlargement/reduction unit 13 and the compressing unit 14. Further, the image processing unit 7 shown in FIG. 1 corresponds to the extension unit 15, the ink-in processing unit 16 and the gradation sequence processing unit 17.

Accordingly, as descried above, if the automatic processing mode is selected, the image data read out from the script supplied from the ADF 10 is stored in the page memory unit 5 with being associated with processing information (for example, including the discrimination information from the image discrimination unit 3 and the setting information supplied from the control panel unit 6). Next, in the case that the image data is read out from the page memory unit 5, the discrimination information indicated by the processing information simultaneously read out, and, for example, the gradation sequence processing by the gradation sequence processing unit 17 in association with this discrimination information (for example, photograph information in which image data is a photograph image) are provided to the read out image data, by the operation of the CPU unit 4 and the image processing managing unit 4-2, and then, they are supplied to the image processing unit 7. The image processing unit 7 automatically provides an optimum image processing for each domain or for each script in association with the image sorts of the image data in this way, so that a color image is formed on a recording medium by using the photo conductor drum, the transfer apparatus or the like (not illustrated).

Hereby, the image forming apparatus M is also capable of performing the optimum image processing to a plurality of scripts for each domain of the image sorts and forming an image provided with the best picture quality by selecting the automatic processing mode to designate the processing of the present invention and reading it by the ADF 10, even if these plural scripts comprise a character script, a photograph script and a character/photograph mixed script. According to various embodiments as described above, those skilled in the art can realize the present invention. However, those skilled in the art can easily arrive at various modified embodiments of these embodiments and it is possible to apply the present invention to various embodiments without an inventive ability. In this way, the present invention covers a wide range, which is not inconsistent with a disclosed principle and a new property, so that the present invention is not limited to the above described embodiments.

For example, in the case that the processing information in association with the image sorts is not stored in the page memory but it is stored in a adjoining register circuit or the like as clearing association with the image data, it is also possible to obtain the same effect.

As described above, according to the present invention, the color digital copying machine provided with the image memory to store the image data designates the automatic processing mode (a mode to designate the processing of the present invention) upon taking in the script by using the ADF, so that the automatic script discrimination and the domain discrimination are performed and the processing information such as the discrimination result or the like is stored in the page memory together with the image data. Hereby, upon reading out the image data from the memory, owing that the optimum image processing is performed in association with the image sorts for each page or for each domain on the basis of the processing information of this discrimination result or the like, the present invention provides an image processing apparatus and an image forming apparatus capable of forming an image having a high picture quality which makes the most of a property of the sort of the script and further, a method for these apparatuses.

What is claimed is:

1. An image processing apparatus comprising:
a memory unit which stores provided image data; and
an image processing unit which reads out the image data of said memory unit and performs predetermined image processing on respective domains of said image data in response to a plurality of processing information for each domain of said image data.

2. An image processing apparatus comprising:
an discrimination unit which discriminates an image sort of the provided image data and outputs discrimination information;
a memory unit which stores processing information including said discrimination information from said discrimination unit together with said image data; and
an image processing unit which reads out said processing information and said image data from said memory unit and provides the image processing indicated by said processing information for each domain of said image data in association with a sort of said discrimination information.

3. An image processing apparatus according to claim 2, wherein said processing information comprises information which indicates what image processing is provided in association with a sort of said discrimination information.

4. An image processing apparatus according to claim 2, further comprising:
a control panel capable of setting said processing information serving as information which indicates what image processing is provided in association with a sort of said discrimination information.

5. An image forming apparatus comprising:
an discrimination unit which discriminates an image sort of provided image data and outputs discrimination information;
a memory unit which stores processing information including said discrimination information from said discrimination unit together with said image data;
an image processing unit which provides the image processing indicated by said processing information for each domain of said image data by reading out said processing information and said image data from said memory unit and associating said processing information and said image data with a sort of said discrimination information; and
an image forming unit which performs image formation on an image recording medium on the basis of the image data provided with the image processing to be supplied from said image processing unit.

6. An image forming apparatus according to claim 5, further comprising:
a scanner unit which continuously supplies a plurality of scripts to a script table by using an ADF and outputs said image data with respect to the plurality of scripts by continuously irradiating a surface of the provided script and scanning it.

7. An image forming apparatus according to claim 5, wherein said processing information is information which indicates what image processing is provided in association with a sort of said discrimination information.

8. An image forming apparatus according to claim 5, further comprising:
a control panel capable of setting said processing information serving as information which indicates what image processing is provided in association with a sort of said discrimination information.

9. An image forming apparatus according to claim 5, further comprising:
a controlling unit including a CPU to control said image processing unit so as to provide the image processing indicated by said processing information for each domain of said image data in association with a sort of said discrimination information of said image processing unit when an automatic processing mode is provided and this automatic processing mode is selected and so as not to perform such image processing when the automatic processing mode is not selected.

10. An image forming apparatus according to claim 5, further comprising:
a controlling unit including a CPU to control said image processing unit and the image forming unit so as to provide different image processings on image data pieces corresponding to a plurality of image recording media having different image sorts according to the image sorts when a Nin1 mode is provided and the Nin1 mode is selected, and further reduce the image data pieces, for forming an image on one image recording medium.

11. An image processing method comprising:
storing provided image data in a memory unit; and
processing an image to read out the image data of said memory unit and perform predetermined image processing on respective domains of said image data in response to a plurality of processing information for each domain of said image data.

12. An image processing method comprising:
discriminating an image sort of provided image data to output the discrimination information;
storing processing information including said discrimination information from said discriminating step together with said image data in a memory unit; and
processing an image to read out said processing information and said image data from said memory unit and provide the image processing indicated by said processing information for each domain of said image data in association with a sort of said discrimination information.

13. An image processing method according to claim 12, wherein said processing information is information which indicates what image processing is provided in association with a sort of said discrimination information.

14. An image processing method according to claim 12, further comprising the step of:
setting said processing information serving as information which indicates what image processing is provided in association with a sort of said discrimination information in a control panel.

15. An image forming method comprising:
discriminating an image sort of provided image data to output discrimination information;
storing processing information including said discrimination information from said discriminating step together with said image data in a memory unit;
providing image processing indicated by said processing information for each domain of said image data by reading out said processing information and said image data from said memory unit and associating said processing information and said image data with a sort of said discrimination information; and
forming an image to form an image on an image recording medium on the basis of the image data provided with the image processing to be supplied from said image processing step.

16. An image forming method according to claim 15, further comprising:
scanning to continuously supply a plurality of scripts to a script table by using an ADF (auto document feeder) and output said image data with respect to the plurality of scripts by continuously irradiating a surface of the supplied script and scanning it.

17. An image forming method according to claim 15, wherein said processing information is information which indicates what image processing is provided in association with a sort of said discrimination information.

18. An image forming method according to claim 15, further comprising:
setting said processing information serving as information which indicates what image processing is provided in association with a sort of said discrimination information via a control panel.

19. An image forming method according to claim 15, further comprising:
controlling the image processing of said image processing step so as to provide the image processing indicated by said processing information for each domain of said image data in association with a sort of said discrimination information of said image processing step when an automatic processing mode is provided and this automatic processing mode is selected and so as not to perform such image processing when the automatic processing mode is not selected by using said CPU.

20. An image forming method according to claim 15, further comprising:
controlling the image processing of the image processing step by using a CPU, to control said image processing unit and the image forming unit so as to provide different image processings on image data pieces corresponding to a plurality of image recording media having different image sorts according to the image sorts when a Nin1 is provided and the Nin1 mode is selected, and further reduce the image data pieces, for forming an image on one image recording medium.
